(19) United States
(12) Patent Application Publication
(10) Pub. No.: US 2013/0189131 A1
(43) Pub. Date: Jul. 25, 2013

(54) WATER COOLED MOTOR WITH STAINLESS STEEL COOLING JACKET

(71) Applicant: Han-Lung Huang, Taicang (CN)

(72) Inventor: Han-Lung Huang, Taicang (CN)

(21) Appl. No.: 13/354,250

(22) Filed: Jan. 19, 2012

(51) Int. Cl. F04B 39/06; H02K 9/19

(52) U.S. Cl. 417/366; 310/54

(57) ABSTRACT

The invention relates to a motor assembly having an electric motor for driving a pressure washer pump, and the electric motor having an integral stainless steel cooling jacket surrounding the motor for efficiently using a liquid, such as water, to conduct heat away from the electric motor.

### BACKGROUND OF THE INVENTION

The invention relates generally to a motor-pump assembly, and, more particularly, to a water cooled electric motor structure for driving a pump discharging pressurized liquid.

Motor-pump assemblies are known in the field, and are particularly useful in connection with high pressure washers. In such a washer, a liquid, preferably water, is fed or suctioned into a pump chamber through an inlet, and then is discharged through a high pressure outlet. The pump is driven by a motor, for example an electric motor; and as the motor heats up, a cooling liquid is, in some embodiments, fed to a cavity surrounding a motor body to draw heat away from the motor. Hoses can be used to provide the water used to cool the motor, and the resulting warmed water can be directed through hoses to the inlet of the pump and hence into the pump's pressure chamber.

Objects of the present invention are a more efficient mechanism and method for withdrawing water and heat away from the motor, thereby allowing for a smaller footprint motor-pump assembly operating at a higher efficiency than prior structures.

### SUMMARY OF THE INVENTION

The invention relates to a motor having an integral stainless steel cooling jacket with an inner wall section and an outer wall section defining an enclosed sealed volume. The volume is formed so the liquid can enter the volume through a cooling jacket in the end can be conducted away from the cooling jacket through a cooling jacket outlet. In one illustrative embodiment, the motor can be used as part of a motor-pump assembly for a high pressure washer where the assembly has the electric motor, the motor driving a pump mechanically, and the pump having an inlet for taking in water or other liquids and an outlet for discharging the pressurized liquids.

In one embodiment of the invention, the integral stainless steel cooling jacket is formed from an inner tubing section and then after tubing section, the outer tubing section having inwardly facing lips, the lips being welded to end his of the intersection to form the sealed volume. Inlet and outlet sections are welded to the outer tubing section to provide access to and from the cooling jacket for the cooling liquid.

### BRIEF DESCRIPTION OF THE DRAWINGS

Other objects, features and advantages of the invention will be apparent from the following description taken together with the drawing in which:

FIG. 1 illustrates a motor-pump assembly according to some embodiments of the present invention;

FIG. 2 is a cross-sectional view of the motor section and cooling jacket according to the motor-pump assembly of FIG. 1;

FIG. 3 is a perspective view of the cooling jacket in accordance with some embodiments of the present invention; and

FIG. 4 is a cross-sectional view of the cooling jacket along lines 4-4 of FIG. 3.

### DETAILED DESCRIPTION OF THE INVENTION

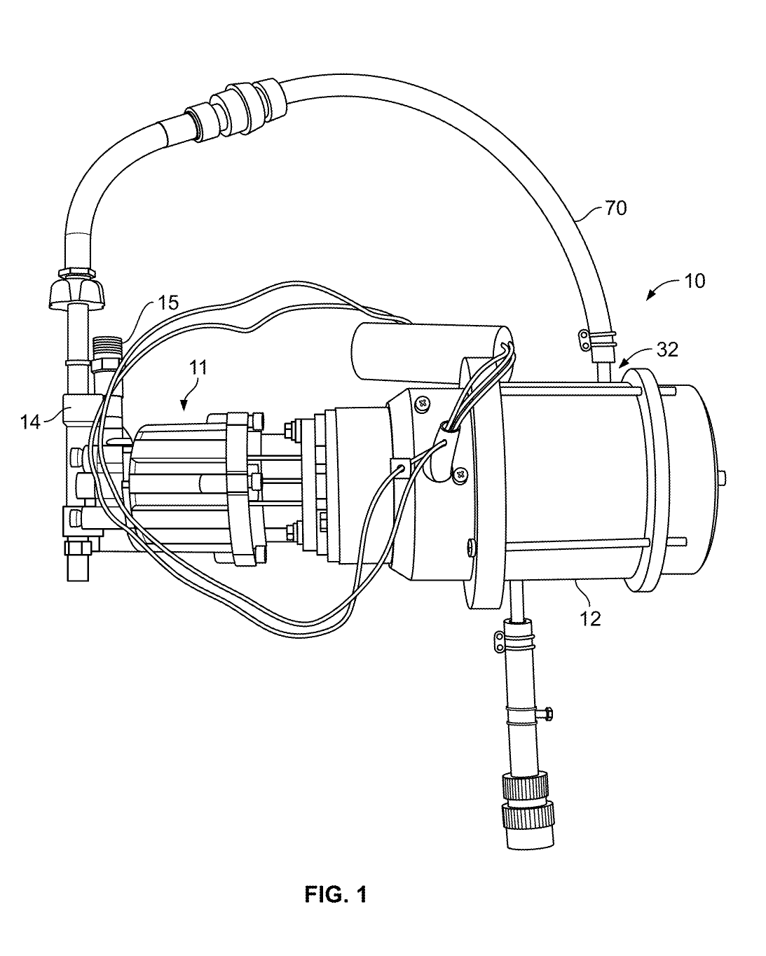

Referring to FIG. 1, a motor-pump assembly 10, according to a particular embodiment of the invention, is used, for example, in high-pressure washer. The assembly 10 has a pump section 11, which may be of the kind described in commonly-owned, commonly-assigned U.S. Patent Application Publication No. 2011/0189041, filed on Feb. 1, 2010 and/or U.S. Patent Application Publication No. 2011/0189031, filed on May 5, 2010, which are hereby incorporated by reference herein in their entireties. In the illustrated embodiment, it is a high pressure water pump. The pump 11 is driven by an electric motor 12, and the illustrated motor can be configured as, for example, a fanOless asynchronous motor.

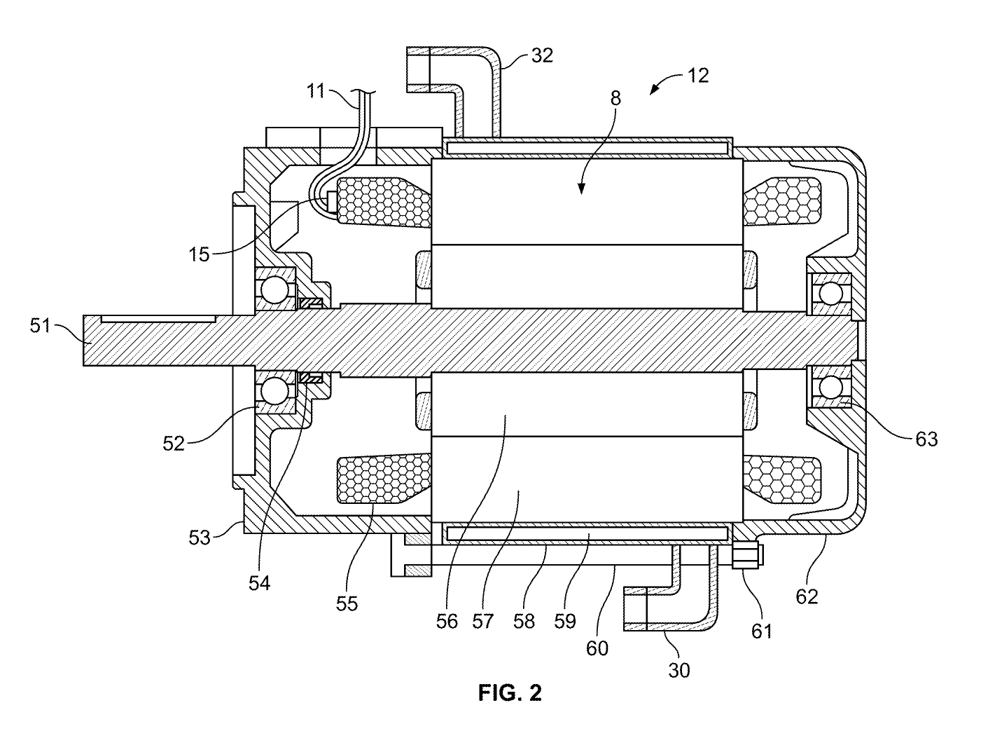

The electric motor 12, as illustrated in FIG. 2, is an illustrative example of the kind of electric motor to which the present invention can be applied. The motor has a drive shaft 51 extending longitudinally through the motor from an end cap (rear end cover) 62 in which rear bearings 63 are positioned. Front bearings 52 sit in an end cover (front end cover) 53 at which there is an oil seal 54. Surrounding the drive motor is a stator iron core 56 and a rotor iron core 57. Lacquered wires 55 make connection to the “outside world”. Surrounding the rotor is a water jacket which contains a fluid such as, initially, cold water. The assembly is held together using screws 60 and nuts 61.

The pump 11, as illustrated generally in FIG. 1, has a suction inlet 14 through which liquid, preferably water, enters a pump chamber. In the pump chamber, the liquid is subjected to pressure, and the pressurized liquid is discharged through an outlet 15. The outlet 15 typically has connected to it, for example, a high-pressure hose with a spray nozzle or a spray lance connected at its distal end as is well known in the field.

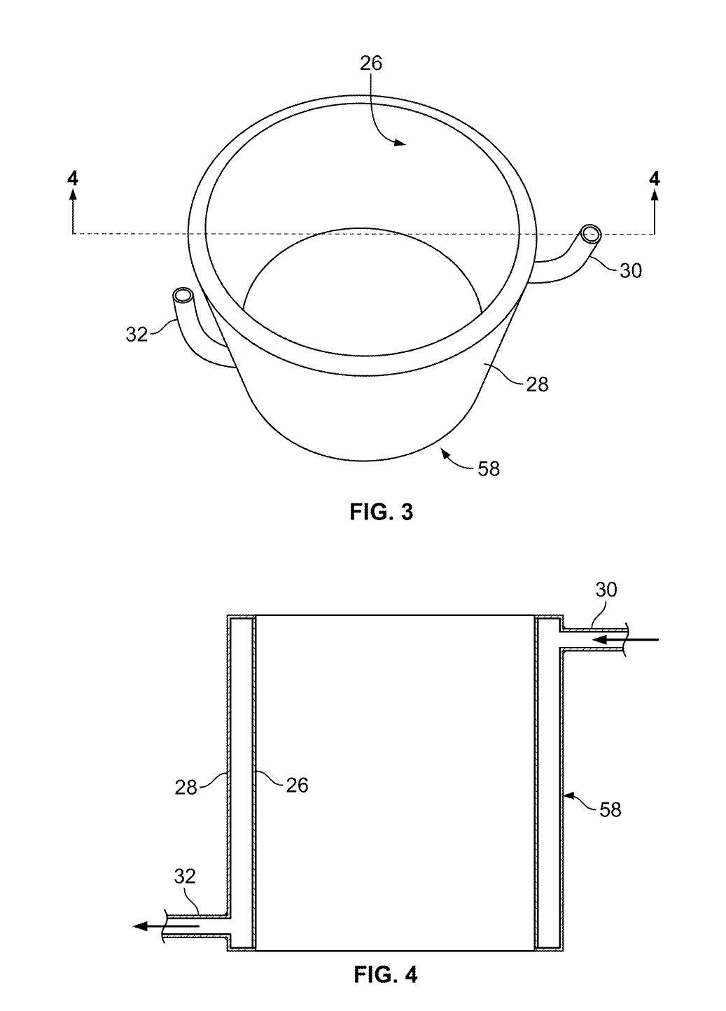

Referring again to FIG. 2, the electric motor 12 has an electrical motor structure 8 which is encircled circumferentially by a cooling water jacket 20 (see also FIGS. 3 and 4). In the particularly described embodiment, the motor cooling jacket 20 is an integrated, welded stainless steel, hollow vessel designed to pass water or another fluid, which will dissipate heat through convection through the jacket surfaces and by removing the heated fluid, preferably water, from the enclosed volume of the cooling jacket which is positioned to encircle the heat generating motor.

Referring to FIGS. 3 and 4, the cooling jacket is manufactured from two formed stainless steel wall members, one wall member 26 being designated the inner member and having a substantially constant circular cross section, and the other wall member being designated the outer member 28 and having inward facing lips at both its top and bottom ends which are welded to the ends of the inner wall of section 26 and then polished to form a smooth outer surface. The completed structure then appears to be a single piece stainless steel structure. In addition, the inlet and outlet elements 30 and 32, respectively, are welded to the outer surface of the outer wall to complete the cooling (water) jacket substantially as indicated in the drawings. The inlet and outlet elements 30 and 32 are bent SUS304 stainless steel tubing, bent and welded to the outer wall. The inner wall is formed (expanded from the inside) from SUS304 stainless steel seamless tubing having, in the illustrated embodiment, a thickness of about two millimeters. The outer wall is formed with inwardly bent lips which are welded to the inner wall and polished. In this illustrative embodiment, they are made from SUS304 stainless steel plate with a thickness of about one millimeter.

In the particularly illustrated embodiment, as described above, the water enters the interior volume of the cooling jacket at an inlet 30 and exits the cooling volume at a location approximately 180° around the circumference and on an opposite end of the jacket, so that water entering one end of the volume must circulate substantially through all of the volume, touching much or all of the interior surface area of the volume. In this manner, the exterior cooling surface of the jacket will be better able to cool the water to the extent possible with the construction provided.

In a preferred and described embodiment, the liquid fed to the pump suction inlet 14 can be passed, prior to entering the inlet 14, through the cooling jacket. For this purpose, use is made, according to the illustrated embodiment of the invention, of hoses (such as hose 70) to connect the jacket outlet 32 to the pump inlet 14. In this manner, the heated liquid from the motor cooling jacket can be used, really reused, and pressurized in the pump section. If necessary, additional water can be combined with the water from the motor, to maintain an adequate flow from the pump.

Accordingly, referring to FIGS. 3 and 4, the motor cooling jacket 20 is configured as an integral single-piece stainless steel unit (welded unit in the illustrated embodiment) and, during assembly of the motor-pump assembly 10, can be pushed axially onto and encircling the motor. The resulting assembly is made rigid by the motor end cap 52, and front end cover 53, and encloses the motor body, which can thus have a smaller size due to its more efficient ability to remove heat from the motor body. The consequent increase in cost due to the use of the completely stainless steel cooling jacket can thus be balanced by the advantageous reduction in size. Further, the motor itself, in tests, has been shown to be more efficient than typical water-cooled motors.

Accordingly, a water cooled motor with stainless steel cooling jacket is provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A motor-pump assembly for a high-pressure washer comprising:
an electric motor; and
a pump mechanically driven by the motor;
wherein:
the pump has an inlet for taking in liquid and an outlet for discharging pressurized liquid; and
the electric motor has an integral, stainless steel cooling jacket having an inner wall section and an outer wall section defining an enclosed sealed. volume formed so that the liquid can enter the volume through a cooling jacket inlet and can be conducted away from the cooling jacket through a cooling jacket outlet.

2. The motor-pump assembly according to claim 1, wherein the integral, stainless steel cooling jacket has annular circular end sections further defining said enclosed volume.

3. The motor-pump assembly according to claim 1, wherein the integral, stainless steel cooling jacket is formed from an inner tubing section and an outer tubing section, the outer tubing section having inward facing lips, and said lips are welded to ends of said inner section.

4. The motor-pump assembly according to claim 1, wherein the integral, stainless steel jacket encloses a hollow volume having a solid cylindrical shape.

5. The motor-pump assembly according to claim 1, wherein the integral, stainless steel cooling jacket is manufactured using a welding and polishing process.

6. A motor assembly for driving a pressure washer pump comprising:
an integral, stainless steel cooling jacket having an inner wall section and an outer wall section defining an enclosed sealed volume formed so that liquid enters the enclosed sealed volume through a cooling jacket inlet and is conducted away from the cooling jacket through a cooling jacket outlet.
